(19) United States
(12) Patent Application Publication
(10) Pub. No.: US 2001/0047512 A1
(43) Pub. Date: Nov. 29, 2001

(54) Method and system for linking multiple processors having shared memory

(76) Inventors: Leland Szewerenko, Pittsburgh, PA (US); David A. Syiek, Pittsburgh, PA (US); Edward A. Anderson, Gibsonia, PA (US); Robert Cyran, Delmont, PA (US)

Correspondence Address: TEXAS INSTRUMENTS INCORPORATED, P O BOX 655474, M/S 3999, DALLAS, TX, 75265

(21) Appl. No.: 09/798,359

(22) Filed: Mar. 2, 2001

Related U.S. Application Data
(60) Provisional application No. 60/191,488, filed on Mar. 23, 2000.

(51) Int. Cl. G06F 9/45

(52) U.S. Cl. 717/10

(57) ABSTRACT

A system for allocating code sections to a plurality of processors is provided. The system includes a linker for allocating and linking the code sections. The system also includes at least one private memory on each of the plurality of processors. The system also includes at least one shared memory accessible by the plurality of processors. The system also includes at least one incomplete link corresponding to the code sections not allocated to the at least one shared memory and the at least one private memory.

### TECHNICAL FIELD OF THE INVENTION

The present invention relates to software development tools, and, more particularly, to software program linking and methods.

### BACKGROUND OF THE INVENTION

Software development is an iterative process. Source code is expressed in a language, such as “C” or assembly, and is organized into multiple text files. Each of these files is processed into a corresponding binary file known as an object file by a compiler and an assembler. A linker combines the object files into a single file. The linker accepts several types of files as input, including object files, command files, and libraries. The linker creates an executable output, or object, module that downloads to one of several devices having an embedded memory. The linked output file may be a complete application, and may be executed on a particular target computer hardware system. Alternatively, the output may be a partial link such that is used as an ingredient in a subsequent link.

To perform the linking process, the linker is given a list of ingredient object files, a description of the target computer memories and directions on how to combine and place the ingredients in the memories. The ingredients may be broken down into “sections” that include blocks of code within the object files to be placed into the memories. During this process, different sections of the compiled application are assigned to various memories of the target hardware system. Embedded systems, such as digital signal processors (“DSPs”), have a plurality of memory types with different sizes, speeds and other characteristics. The allocation of application code and data to the different locations in memory affects the performance of the application after it is embedded onto the hardware system.

Referring to FIG. 1, a software development system 100 is depicted. As described above, text files 102 and 103 are source code written by a programmer. Text files 102 and 103 may represent a plurality of text files. Compiler 104 translates the source code in text files 102 into assembly language source code. Text files 103 represent assembly language source code files written manually. Assembler 106 translates the assembly language source files from compiler 104 or a programmer. Machine language object files 108 are outputted from assembler 106. Object files 108 may be known as object programs or object modules. As described above, object files 108 are the corresponding binary files to text files 102 and 103, either alone or in combination.

Linker 110 combines object files 108 into a single executable object module, or output file 114. In addition to object files 108, linker 110 accepts library files 112 containing multiple object files. Linker 110 also allows for the combination of object file sections, binds sections or symbols to addresses within memory ranges, and defines or redefines global symbols. After linking operations are completed, output file 114 is downloaded to processor 116. Thus, the sections in object files 108 are distributed into the memories in processor 116 according to instructions placed in output file 114 by linker 110.

FIG. 2A depicts a known linker within a software development system 200. Linker 110 is given a list of object files 108, a description of the computer hardware memory, and directions on how to combine and place object files 108 in linker commands 206.

Linker allocation directions in linker commands 206 are expressed in a custom text-based command language. A user inputs and edits linking instructions in text editor 204. Text editor 204 translates the instructions into command file 206 to be inputted into linker 110. The user studies the textual linker output in map file 208 and errors 210 for the results of the linking instructions and makes any necessary changes to command file 206. This process is repeated until the desired results are obtained. Linker 110 receives object files 108 and library files 112. As described above, output file 114 may be an executable application.

FIG. 2B depicts a flowchart of a known method for performing linking operations using a known linker. Step 221 executes by starting the linking operations in linker 110. Step 222 executes by linker 110 reading ingredient files and commands, such as object files 108, libraries 112 and linker commands 206. Step 224 executes by linker 110 allocating the sections, or blocks, of code to the private memories within the processor. Linker 110 uses the instructions written in linker commands 206 to allocate the sections. Step 225 executes by defining the value of symbols according to the allocation of the sections of the ingredient files. Symbols, and symbolic references, represent calls or branches within a section of code to another section of code. As the sections are located at a specified address in a memory, references to the individual sections is made by symbols. Linker 110 defines the symbols, as references to them are resolved in a subsequent step.

Step 226 executes by determining whether all symbolic references have been satisfied by linker 110. If no, then step 230 executes by issuing an error signal or message. If yes, then step 228 executes by determining whether the sections of code fit in the target memories. If no, then step 230 executes by issuing an error signal or message as a problem has arisen that must be resolved. If yes, then step 240 executes by relocating symbolic references in the allocated sections of code. This relocation may be done manually within the sections. Step 242 executes by writing output file 114 and link map file 208 for review by a user.

Step 232 executes by denoting a failure has occurred in the linking operations. Step 232 may execute subsequent to the error message in step 230. Step 244 executes by denoting the linking operations have been successful.

FIG. 3 depicts a known linker that allocates object files to a memory. Linker 110 includes allocation module 316 and output module 318. Ingredient 300, or object file A, includes sections A1, A2, and A3. Ingredient 302, or object file B, includes sections B1 and B2. Ingredient 304, or object file C, includes section C1. The sections may represent blocks of code. Object files A, B, and C may be object files within an object oriented program.

Allocation module 316 inputs linker commands 206. Linker commands 206 are a set of instructions that tell allocation module 316 where to place the sections of object files A, B, and C in the target computer hardware memories. Memories 312 and 314 represent memory space within the target memories. Memories 312 and 314 have different locations and addresses. Using the linking instructions, allocation module 316 places each section within the ingredients in a memory space. For example, allocation module 316 places section A1 of object file A in memory 312 at a specified location. Allocation module 316 also places section B1 of object file B in memory 312 at another location, different from the location of section A1.

Allocation module 316 also resolves any issues regarding symbolic references within the sections of the object files. Sections may have calls, or branches, to subroutines in other sections within the object files, or even to other object files. These calls are represented by symbols within the code. As the sections of code are linked within memories 312 and 314, the symbolic references within these calls are replaced by address locations within the memory.

Referring to FIG. 4, a linker symbol resolution system is depicted. Ingredients 420 include object files having a plurality of sections of code, including sections 400 and 405. Section 400 includes a code block 402 that contains a definition of a branch label A. Code block 402 also includes other information. Section 400 also includes a symbol dictionary block 404 that lists symbol A as being defined in section 400, and has an offset of 20 from the origin of code block 402.

Section 405 includes a code block 406 and a symbol dictionary block 408, similar to section 400. In code block 406, a branch instruction lists branch label A as its target. Symbol dictionary block 408 lists symbol A as being a reference to a definition elsewhere without a known offset as section 400 has not been allocated to a memory location.

During the allocation phase of allocation module 316 in FIG. 3, linker allocation decision module 422 allocates sections 400 and 405 of ingredients 420 to specific addresses in the target computer hardware memory. Linked output file 424 includes allocated sections 410 and 411 that correspond to section 400 and 405, respectively. Branch target 412, or label A, is located within allocated section 410. Further, branch instruction, or call, 414 to label A is located within allocated section 411. Branch instruction 414 is known as a symbol reference within allocated section 411.

The base, or beginning, addresses of sections 400 and 405 are recorded in table block 423 inside linker 110. For example, the base address of section 410 is memory address 2000. Referring to symbol dictionary block 404, symbol A has an offset of 20 from the base address. Thus, branch target 412, or label A, is located at address 2020 within the memory.

During the relocation and output steps of the linking operations, all symbol references 414 are replaced by actual addresses computed by adding the symbol offsets in the symbol dictionaries to the section base addresses in table block 423. These addresses are inserted into the linked code, such as symbol reference 414. Thus, the symbol references are replaced by address locations by linker 110.

Referring back to FIG. 3, after allocation module 316 completes the allocation of the sections of object files A, B, and C, then output module 318 links the sections within the memories to generate output file 114 that represents an application to be run on a target computer system.

The linking process involves a preparation period for a user to resolve any errors with the linking process, as described in step 230 of FIG. 2B. Known linkers report errors and may fail to complete the allocation of the ingredients object files if there are unresolved symbolic references. Thus, if the list of input object files and libraries is not complete, then an error occurs within the linking process. The user then re-edits command file 206 to improve or adjust the linking instructions. This activity inhibits interactive allocation strategies in which a user attempts to optimize the allocation of only a part of the ingredients of the software program before the remaining parts of the program are available or written. No links may be left incomplete. Therefore, extensive experimentation is prohibited and users are discouraged from finding more optimal ways of linking.

These tools are appropriate for simple applications, but may not be able to adequately optimize complex applications or memories. Further, known linkers are unable to resolve incomplete links. Referring back to FIG. 2B, all sections must fit in memories before an output file may be created or the symbol references resolved. This requirement inhibits interactive linking strategies as all links must be complete before a map file is generated for review by the user. Further, known linkers only resolve allocation issues on a single memory configuration.

As software applications evolve, the ingredients change as do the sizes and the properties of the individual ingredient object files 108. The instructions in command file 206 for allocation of a target system memory may become obsolete periodically and require maintenance. Directions are updated to interface with new hardware target system memories.

FIG. 5 depicts multiple processors having private memories and a shared memory. Unlike the linker system depicted in FIG. 2A, this system includes two processors, processor 501 and processor 503. This system also may include many more processors. Processor 501 also may be known as processor A, and processor 503 also may be known as processor B. Processor 501 includes a memory 505, or a private memory A, and flash memory 511. Processor 503 includes memory 507, or private memory B. Processors 501 and 503 also have access to shared memory 509.

Shared memory 509 differs from memories 505, 507 and flash memory 511 in that the data within shared memory 509 is accessible directly by both processors 501 and 503. Shared memory 509 allows applications and processors 501 and 503 to exchange data more quickly than by reading and writing using typical operating system services. Thus, shared memory 509 is a memory wherein all, or a part, is accessible simultaneously from more than one processor component. Processors 501 and 503 may be heterogeneous processed components in that they have two or more central processing units that include different instruction set architectures.

Memories 505 and 507 may be random access memories wholly dedicated to their respective processors. For example, memory 505 is dedicated to processor 501. Flash memory 511 stores data when power is down within the processors 501 and 503. The data stored within flash memory 511 is not lost when in an “off” state, unlike memories 505 and 507. Boot code stored in flash memory 511 is copied from flash memory 511 to memory 505 when power is “on” for processor 501. If memory 505 is random access memory, code or data from flash memory 511 is copied directly into memory 505 until power is turned off for processor 501.

The code stored in flash memory 511 includes two parameters. The first parameter is the boot, or load, address that indicates the location in flash memory 511 the code for booting up processors 501 and 503 resides. The second is the run-time address that indicates where the code or data resides during operations on the processors.

Problems may occur when allocating code from an output file from a linker to memories 505 and 507 in shared memory 509. Typically, linkers may produce a program from only one single instruction set architecture (“ISA”) at a time.

Referring to FIG. 6, a known method for linking output files for heterogeneous processor components having a shared memory is depicted. Step 600 executes by linker 110 allocating code for processor 501, or processor A. Step 600 executes in a fashion similar to that described in FIG. 2B. Linker 110 considers memories 505, 507 and shared memory 509 in its allocation decisions. After the code has been allocated, map file 208 lists the addresses where the code has been allocated in order to operate processor 501. Step 602 executes by a user reading output within map file 208 of step 600 to determine where code sections for processor 501 were stored. The user then manually text edits, or hard code addresses, processor 503's code sections in memory 509. Shared memory 509 may be the random access memory shared by processors 501 and 503. The user performs step 602 by hard-coding the addresses from the map file 208, or A.map, correlating to the linking operations for processor 501 into the command file, or linker commands 206, s for processor 503. These hard-coded addresses refer back to the exact addresses where the code sections according to processor 501 have been stored. Step 604 executes by linker 110 allocating for processor 503 are considering memories 507 and 509 and the instructions developed in step 602.

In the method described by FIG. 6, any code allocation strategies for processor 501 impacts the linking strategies for processor 503. Any changes of code sections for processor 501 result in hard-code changes for processor 503. Shared memory 509 is treated as owned by a particular processor 501 and 503 depending upon which linking allocation strategies are being implemented. Time-consuming errors and inefficiencies result from the inability to treat the entire computer system object in the software as a single entity. Further, separate linkers may have to be used for each particular processor. For example, processor 501 may use linker 110 in implementing code allocation. Processor 503 may require a different linker to implement code allocation strategies in memory 507.

Linking operations impact performance on embedded processors, such as digital signal processors. Unlike general purpose processors having a single, large memory, embedded processors have many different memories. The layout of the application into various target memories impacts performance. Certain kinds of fast memory, such as on-chip memory, are limited in space and desired for critical application functions. Trade-offs are made depending on the size of the programmer's application plus any libraries. As the program evolves and grows, the allocation decisions are revised in a time-consuming manner.

Further, known linkers are problematic when creating a software program to be executed on a multiprocessor computer system involving heterogeneous processor components, local memory components, and shared memory components. Linkers produce a program for a single processor at a time. If a system includes more than one processor, a separate link step is executed for each processor. Furthermore, if the processors are of different types, or different ISAs, then the multiple link steps are performed with different linkers. So not only are there multiple steps, they require different tool sets.

Different tool sets, such as compilers and assemblers, for each ISA typically produce object files in different formats for the linker. Known linkers may read only one format at a time.

### SUMMARY OF THE INVENTION

From the foregoing it may be appreciated that a need has arisen for a system and method for linking multiple processors. In accordance with one embodiment of the present invention, a method and system for linking multiple processors is provided that substantially eliminates and reduces the disadvantages and problems associated with conventional linkers in software development systems.

In an embodiment of the present invention, a system for allocating code sections to a plurality of processors is provided. The system includes a linker for allocating and linking the code sections. The system also includes at least one private memory on each of the plurality of processors. The system also includes at least one shared memory accessible by the plurality of processors. The system also includes at least one incomplete link corresponding to the code sections not allocated to the at least one shared, memory and the at least one private memory.

In another embodiment of the present invention, a method for allocating code sections to a plurality of memories is provided. The plurality of memories include shared memories accessible by a plurality of processors and private memories on the plurality of processors. The method includes the step of receiving instructions to allocate the code sections. The method also includes the step of allocating the code sections to the shared memories and the private memories with a linker. The method also includes the step of updating incomplete links corresponding to code sections not allocated in the allocating step.

The incomplete link may include a list of ingredient object files that are not complete or are missing. The incomplete link also may include ingredient object files or sections that have been allocated or not allocated. This incomplete link results in some symbolic references not being resolved at the completion of linking operations.

The feedback from the incomplete link includes the allocated position and size of the sections that are allocated to memory, the values of symbols that are allocated, a list of symbolic references that are not defined, and a list of ingredient object files and sections that are not allocated. Therefore, the user may select or experiment with linking instructions without the need for verification.

Further, the user or software program may complete incrementally an incomplete link by a plurality of commands, either alone or in combination. The commands include allocating and deallocating code sections, and reallocating additional sections to be allocated. The commands also include defining or redefining symbols. The commands also include adding or removing ingredient object files or code sections. The commands also include any other linking or allocating instructions indicated by the user.

The present invention also includes a linker that allows other software programs or program components to build an executable program for an embedded processor having multiple memory types. The linker also provides feedback to the programs or components and enables the program or component to incorporate the incomplete links described above. The program, or component, may issue a plurality of commands, either alone or in combination, to the linker. The commands include adding or removing ingredient object files or code sections to be included in the linking operations. The commands also include specifying the sections from the ingredient files that are to be allocated. The commands also include deallocating or reallocating sections previously allocated. The commands also include specifying a memory area within a plurality of processors having a shared memory that allocate certain sections, various kinds of sections, and/or various object files. The commands also include specifying constraints on the allocation of certain sections and object files, such as specifying absolute addresses for sections or symbols, or specifying alignment constraints on addresses for sections or symbols. The commands also include specifying the order that sections and object files are allocated. The commands also include defining new symbols that are referenced by object files during linking operations. The commands also include specifying characteristics of the allocation strategy, such as specifying those sections that are not referenced by other sections that may be included in the linking operations.

The linker provides feedback from the linking operations. Feedback is information passed from the linking operations back to the controlling software program or component so that the program or component may perform additional operations. Via the linker, the controlling software program or component may determine the address assigned to a section or symbol during linking operations. The program or component may determine the length of a section. The program or component may determine whether any section is not allocated as specified. The program or component may determine whether any control action succeeded or failed. Further, the interface between the linker and other software programs or components allows more than one program or component to simultaneously control and/or receive feedback during linking operations.

The present invention allows a description to be read to the linker of a multiprocessor system comprising different processor components, local memory, and shared memory. The present invention allows the linker to simultaneously read ingredient object files in multiple formats. The present invention allows the linker to resolve references between software components for heterogeneous processors. The present invention allows the linker to perform shared allocation of objects defined in software components, for multiple processors without intervention. The present invention allows the linker to output one or more software programs that may be loaded together onto specific processors for execution.

A technical advantage of the present invention is that a linker is provided. Another technical advantage of the present invention is that a linker is provided that is portable and compatible with multiple embedded memory systems. Another technical advantage of the present invention is a visual linker interacts with other software tools.

Another technical advantage of the present invention is that the visual linker allows a user to view visual and graphical memory layouts while adjusting memory allocations. Another technical advantage of the present invention is that the time to develop linking process instructions and strategies is reduced. Another technical advantage of the present invention is that a visual linker is provided with increased functionality. Another technical advantage of the present invention is that the visual linker allocates blocks of code to embedded memory machines without running confidence check programs and in reduced time.

### BRIEF DESCRIPTION OF THE DRAWINGS

For a more complete understanding of the present invention, and the advantages thereof, reference is now made to the following descriptions taken in connection with the accompanying drawings, in which:

FIG. 1 illustrates a known software development system.

FIG. 2A illustrates a known linker system.

FIG. 2B illustrates a flowchart depicting a known linking method.

FIG. 3 illustrates a known linker having allocation and output modules.

FIG. 4 illustrates a known linker symbol resolution system.

FIG. 7 illustrates a linker within a software development system having a plurality of processors and a shared memory in accordance with an embodiment of the present invention.

FIG. 8 illustrates a flowchart depicting a method for linking multiple processors having a shared memory, using a linker in accordance with another embodiment of the present invention.

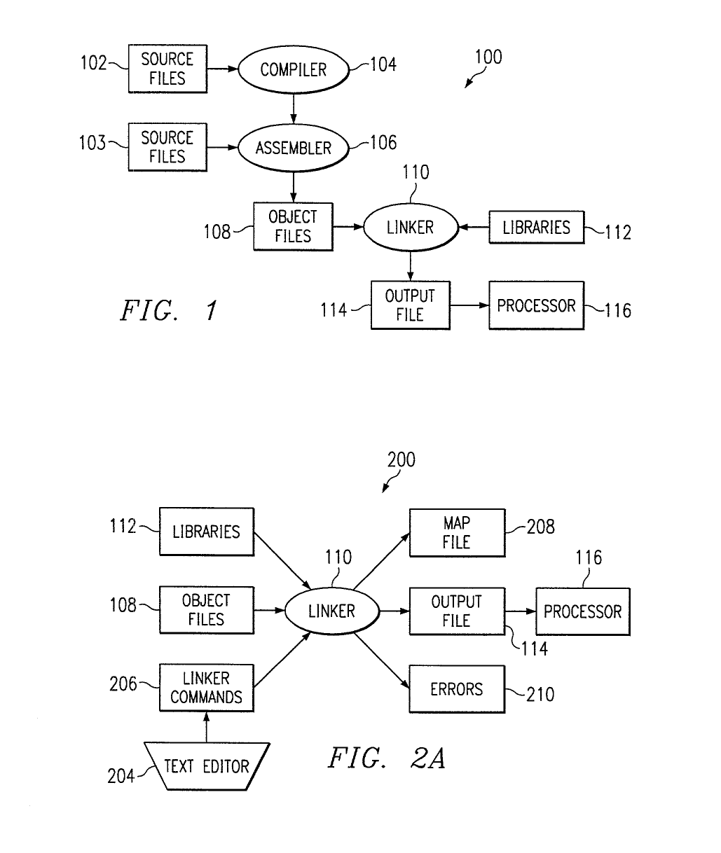

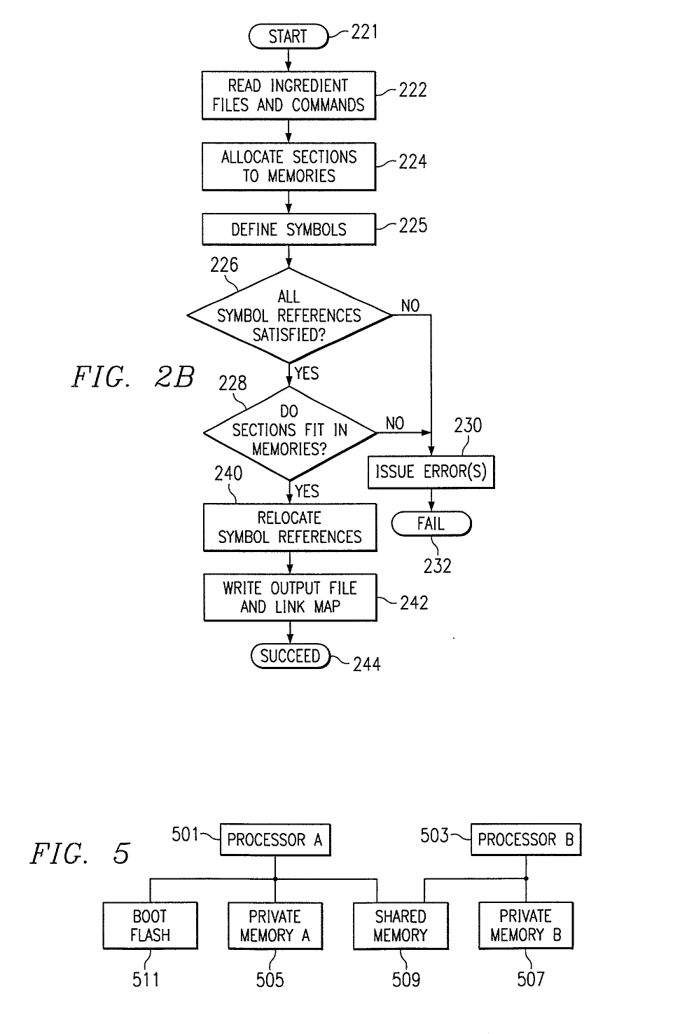

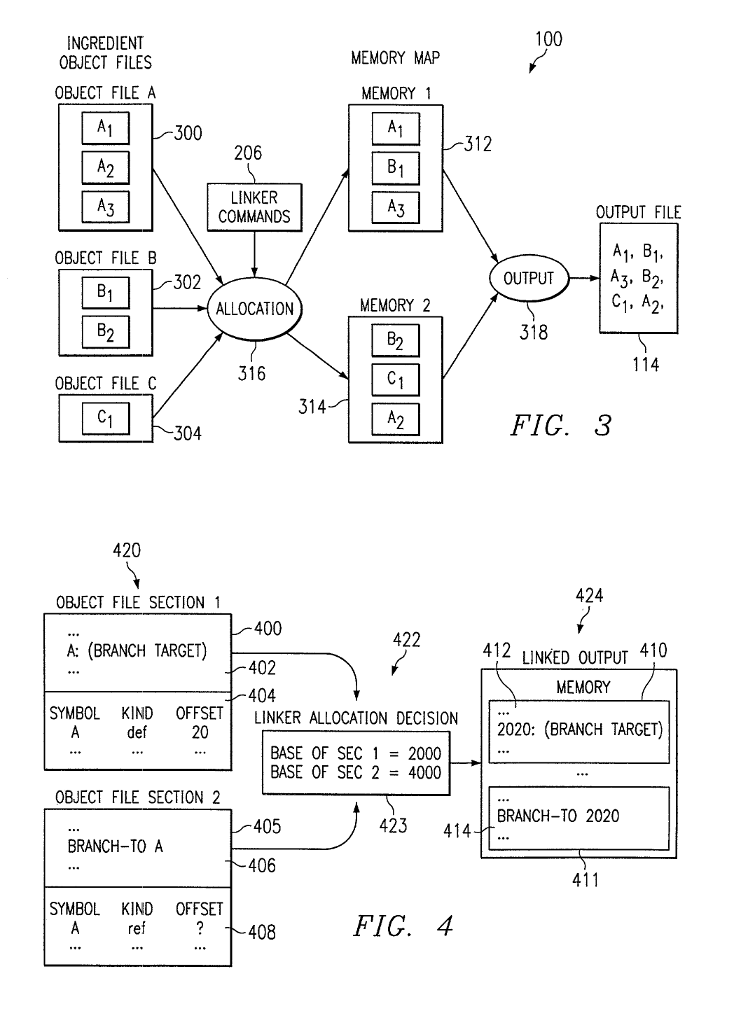

### DETAILED DESCRIPTION OF THE INVENTION

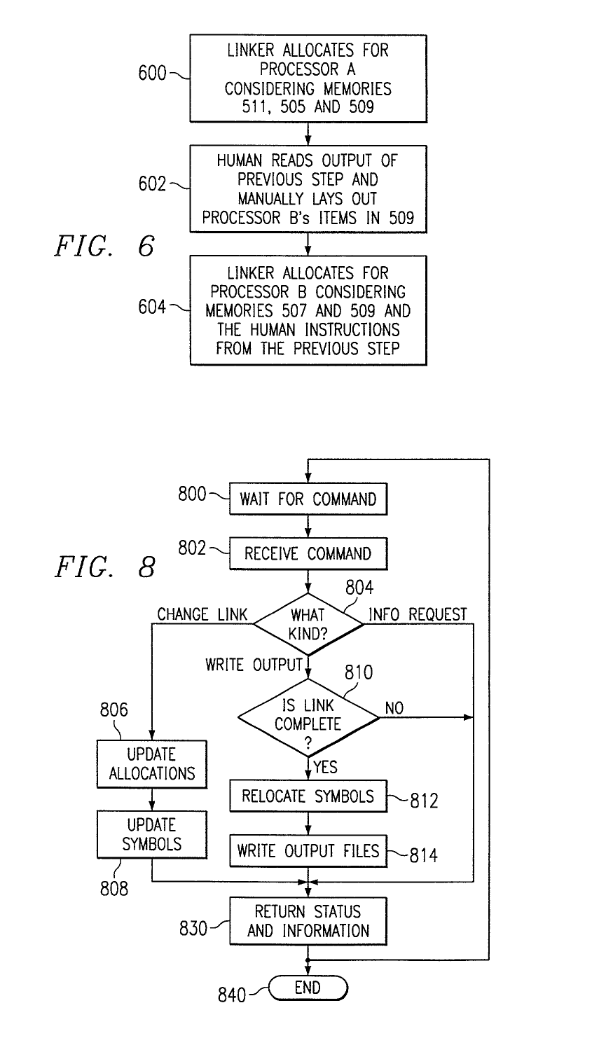

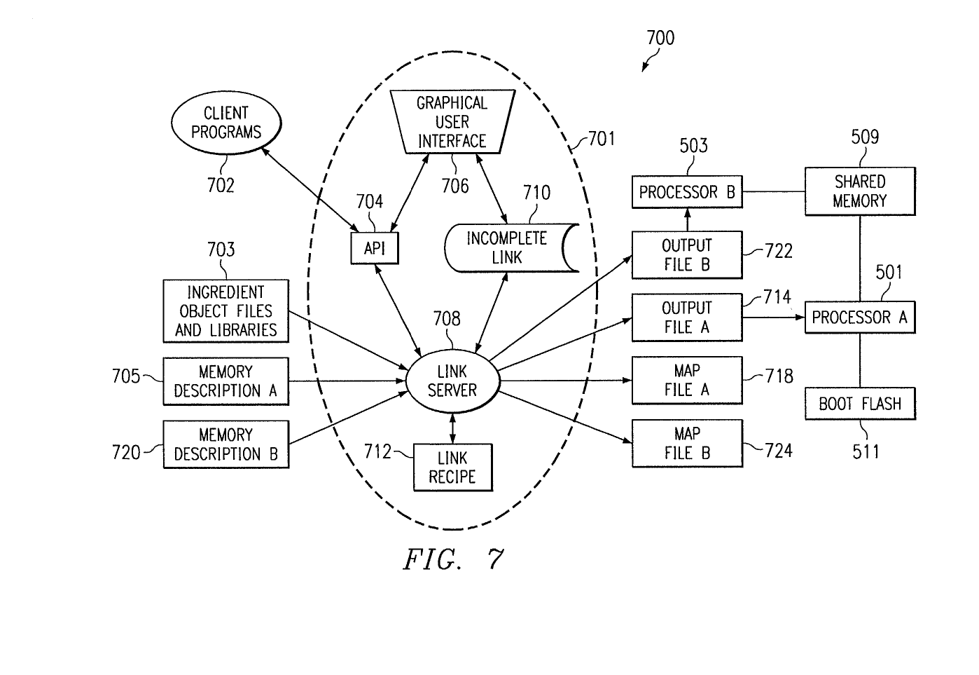

An embodiment of the present invention and its advantages are best understood by referring now in more detail to FIGS. 7 and 8 of the drawings, in which like numerals refer to like parts. FIGS. 7 and 8 illustrate one embodiment of the present invention.

FIG. 7 depicts a software development system 700 in accordance with an embodiment of the present invention. Software development system 700 includes visual linker 701. Visual linker 701 is a visual, interactive, extensible linker. Visual linker includes link server 708, graphical user interface (“GUI”) 706, and API 704. Visual linker 701 also includes incomplete link 710 and link recipe 712. Visual linker 701 inputs a list of input object files and libraries within ingredients 703. Visual linker 701 also inputs memory descriptions 705 and 720 for processors 501 and 503, respectively. Processors 501 and 503 may include heterogeneous processor components. Preferably, at least one of processors 502 and 503 is a digital signal processor.

A user developing a linking strategy executes a linking process using visual linker 701. The user interfaces with visual linker 701 via GUI 706. GUI 706 may be on a display, such as a computer monitor, that displays a graphical representation of the memory layouts within processors 501 and 503. GUI also displays a memory layout of shared memory 509. GUI 706 also may connect to a keyboard or mouse that allows a user to send gestures or commands to visual linker 701. For example, a gesture may include using drag-and-drop methods. Using GUI 706, a user may allocate ingredients 703 to a Layout of the memories for processors 501 and 503, and shared memory 509. By receiving linking instructions via GUI 706, visual linker 701 specifies how object files, library files, and other files within ingredients 703 are to be allocated. After each instruction, the user views the results of the linking instructions. These results include how much memory is allocated to the sections of ingredients 703, and how much memory of processors 501 and 503, and shared memory 509.

GUI 706 displays the results of the linking operations by showing those sections of code within ingredients 703 that are allocated. GUI 706 may display this information in a variety of ways. This feature is available because GUI 706 and link server 708 share the same data structure. Visual linker 701 includes both components. Thus, visual linker 701 via GUI 706 may display the output grouping of sections, or output groups, in a hierarchical visual tree, such that output groups may contain input sections or other output groups. Visual linker 701 provides a hierarchical, visual tree view of private memories 505, 507 and shared memory 509. Further, visual linker 701 provides a hierarchical, visual tree view of incomplete link 710. In addition, visual linker 701 provides a layered memory picture via GUI 706 such that the layers correspond to a hierarchical tree view of output sections, including output sections of incomplete link 710.

Further, client software programs 702 specify linking instructions or commands. The instructions or commands are received by API 704 and passed onto link server 708. Link server 708 then implements the instruction. Thus, visual linker 701 allows other software programs or program components to build an executable program for target computer hardware memories. Visual linker 701 also enables client programs 702 to accept or modify incomplete link 710, as described below.

Visual linker 701 includes incomplete link 710. Incomplete link 710 may represent a list of object files within ingredients 703 that are not complete in that some files are missing. Incomplete link 710 also may represent object files having sections that have been allocated and sections that have not been allocated. Further, incomplete link 710 represents the result of the symbolic references not being resolved. The symbolic references are not resolved because not all code sections have been allocated to a location in the target memories represented by memory descriptions 705 and 720. Preferably, more than one incomplete link 710 exists in visual linker 701.

Visual linker 701 reports the status of incomplete link 710 back to the user via GUI 706 or to client programs 702 via API 704. Visual linker 701 may report the allocated position and size of allocated sections from the object files of incomplete link 710. Visual linker 701 also may report the values of symbols that have been allocated to a memory location in incomplete link 710. Further, visual linker 701 also may report the list of symbolic references that are not defined by incomplete link 710, as their location in the target memory has not been specified. Moreover, visual linker 701 may report the list of object files or sections of ingredients 703 that have not been allocated by link server 708.

After the user or client programs 702 receives the status of incomplete link 710, further instructions or commands are issued to incrementally complete incomplete link 710. The user uses gestures via GUI 706 and client programs 702 use commands via API 704 to allocate, deallocate or reallocate additional sections of the object files and libraries within ingredients 703. The changes to incomplete link 710 resulting from these actions are reported back through GUI 706 or API 704. Symbols within incomplete link 710 may be defined or redefined as a result of the actions received by visual linker 701. In addition, commands or gestures received may add or drop ingredient object files or sections from incomplete link 710. Thus, incomplete link 710 is modified in an event driven manner by commands or gestures received through API 704 and GUI 706. The commands or gestures manipulate link server 708, which, in turn, modifies incomplete link 710.

Client programs 702, or a user, control visual linker 701 with a plurality of actions. Specifically, visual linker 701 is event-driven in that external events are received by GUI 706 and API 704. GUI 706 and API 704 translate the received events into linking instructions. The events include gestures through GUI 706, such as drag-and-drop, and commands issued by client programs 702 through API 704.

The linking instructions control visual linker 701 and the resulting linking process. Thus, client programs 702 may control visual linker 701 by adding or removing object files or sections within ingredients 703 that are included in the link by link recipe 712. Client programs 702 also may control visual linker 701 by specifying the sections of code from ingredients 703 are to be allocated by link server 708. Further, client programs 702 may control visual linker 701 by deallocating or reallocating sections of ingredients 703 previously allocated according to memory description. This feature is desirable when memory description 705 has been modified or updated.

Visual linker 701 also receives input via GUI 706 and API 704 that specifies the memory area within processors 501 and 503, or shared memory 509, and as described in memory descriptions 705 and 720, into which particular sections are to be allocated by link server 708. Various kinds of sections or object files, such as libraries, also may be allocated by specifying a memory area.

Client programs 702 controls visual linker 701 via API 704 to specify constraints on the allocation of particular sections and object files. These instructions may specify absolute addresses for certain sections or symbols, or specify alignment constraints on addresses for sections or symbols. Further, these instructions may specify a specific order to allocate sections and symbols within ingredients 703 and 720.

Client programs 702 controls visual linker 701 via API 704 to define new symbols in the code sections of ingredients 703 that may be referenced by other object files in the link generated by link server 708. Client programs 702 controls visual linker 701 through API 704 to specify characteristics of the allocation strategy, such as specifying those sections that are not referenced by other sections that are included in the link generated by link server 708.

Visual linker 701 provides feedback to client programs 702 on the status of linking operations or the results of events performed. API 704 passes information to link server 708. After receiving the information, client programs 702 may take further action, or may define further events. Client programs 702 may use this information from visual linker 701 to determine an address assigned to a section or symbol by link server 708, or to determine the length of an allocated section. Client programs 702 also may use the information from visual linker 701 for integrity checks, or optimizing the linking process. For example, client programs 702 may determine whether any code section is not allocated as specified by the received linking instructions, or whether any control action mentioned above succeeded or failed.

A user may control visual linker 701 in a similar manner to client programs 702 via GUI 706. Thus, visual linker 701 is controlled according to the operations described above by more than one entity. In addition, the user may use feedback from visual linker 701 via GUI 706 to determine the status of the links and other parameters, as described above. With the interfaces of API 704 and GUI 706, multiple entities may control and receive feedback from visual linker 701.

As visual linker 701 receives linking instructions from the user or client programs 702, a linking recipe 712 is generated. Linking recipe 712 may be a set of linking instructions or strategies translated by API 704 or GUI 706 that describe how visual linker 701 is to be controlled. Link server 708 implements the instructions and generates the step to be included in linking recipe 712.

Linking recipe 712 allows the steps of the recipe to be executed, without user interaction, to obtain the same effect as the sequence of gestures. Linking recipe 712 also allows the steps of the recipe to be viewed and changed on an individual basis. Linking recipe 712 may be stored as a file, or imported into other recipes to perform all or part of a link. Thus, visual linker 701 keeps a record of all events received and performed by API 704 and GUI 706. Further, link server 708 may access linking recipe 712 to modify or adjust linking recipe 712.

By creating linking recipe 712, visual linker 701 generalizes the events received from the user or client programs 702. These events may include gestures or commands, and are translated by API 704 and GUI 706. A consecutive series of events that moves each section of a particular type is generalized to a step in linking recipe 712 that moves all sections of that type to the specified memory area. Further, an event that moves each section currently referenced by a particular section is generalized to a step that moves any section referenced by the particular section to that location. An event that moves each section of a particular object file is generalized to a step that moves all sections from the particular object file. Thus, the steps of linking recipe 712 allow for a strategy that includes control of visual linker 701 to allocate sections that may exist in a future link and meet a specified criteria to be allocated according to linking recipe 712 without revisions or updates.

Complete, linked output files 714 and 722 are generated after the sections of ingredients 703 are allocated by visual linker 701. Output files 714, or output file A, is downloaded into memory 505 and flash memory 511 on processor 501. Output file 722, or output file B, is downloaded into memory 507 on processor 503, or processor B. The layout specification, or link strategy, is reflected in linking recipe 712. Shared memory 509 also is included in the linking strategies described in linking recipe 512. Output files 714 and 722 also contain sections of code to be allocated to shared memory 509. As described above, visual linker 701 resolves incomplete links 710 during linking operations. This includes those incomplete links to shared memory 509. Further, because GUI 706 allows the user to view layouts of memories 505 and 507, and shared memory 509, the need for coding one processor at a time is eliminated. In other words, visual linker 701 performs linking operations for a plurality of processors that may or may not have different instruction set architectures.

FIG. 8 depicts a flowchart of a method for linking multiple processors having a shared memory in accordance with another embodiment of the present invention. Step 800 executes by waiting for a command via API 704 or a gesture via GUI 706. Step 802 executes by receiving the command or gesture and translating it into a linking instruction to control visual linker 701, and, in particular, link server 708. The command or gesture includes which memory 505, 507, 509, or 511 is the subject of the allocation instruction.

Step 804 executes by determining the type of instruction received. Step 806 executes if the instruction is a change link instruction that modifies an existing link or incomplete link 710. As described above, more than one incomplete link 710 may exist in visual linker 701. This step identifies which incomplete is to be modified. A change link instruction may control visual linker 701 as described above. After the changes have been made in step 806, step 806 executes by updating the allocations made to memories 505, 507, 509, or 511 defined in memory descriptions 705 and 720. Step 806 also updates allocations made to shared memory 509, regardless if the sections of code to be allocated are from processor 501 or processor 503. Step 808 executes by updating the symbols impacted by the command received in step 800.

If the command, or instruction received in step 804 is an information request instruction, then step 830 executes by determining the status of the links, including incomplete link 710, and visual linker 701 and returning that status and other information via API 704 or GUI 706. Information to be reported may include the amount of memory allocated to sections of code within memories 505 and 507. Further, a status may include the sections of code allocated to shared memory 509. Incomplete link 510 may correlate to shared memory 509, or memories 505, 507 and 511.

If the instruction received in step 804 is a write output instruction, then step 810 executes by determining whether the link defined by the linking operations within visual linker 701 is complete. If no, then step 830 executes by returning the status of the link and other information via API 704 or GUI 706. If yes, then step 812 executes by relocating the symbols defined in ingredients 703 and allocated by link server 708. Step 814 executes by writing output files 714 and 722 and map files 718 and 724 for processors 501 and 503, respectively. Output files 714 and 722 also include the linking allocations to shared memory 509. Step 830 executes by returning the status of the link and other information. Step 840 executes by completing linking operations. Thus, the method is an iterative process that allows visual linker 701 to receive instructions and review the changes within the link of visual linker 701 for multiple processors having a shared memory prior to generating output or map files.

Thus, it is apparent that there has been provided, in accordance with an embodiment of the present invention, a linker for linking multiple processors having a shared memory that satisfies the advantages set forth above. Although the present invention has been described in detail, it should be understood that various changes, substitutions, and alterations may be made herein. Other examples are readily ascertainable by one skilled in the art and may be made without departing from the spirit and scope of the present invention as defined by the following claims.

What is claimed is:

1. System for allocating code sections to a plurality of processors, said system comprising:
a linker for allocating and linking said code sections;
at least one private memory on each of said plurality of processors;
at least one shared memory accessible by said plurality of processors; and
at least one incomplete link corresponding to said code sections not allocated to said at least one shared memory and said at least one private memory.

2. The system of claim 1, wherein said at least one private memory is a random access memory.

3. The system of claim 1, further comprising a link server within said linker that implements linking instructions for said code sections.

4. The system of claim 2, further comprising a graphical user interface within said linker that receives said instructions and display said code sections allocated to said at least one shared memory and at least one private memory.

5. The system of claim 2, further comprising an application programming interface that receives said instructions and reports the results of said linking instructions and said code sections allocated to said at least one shared memory and said at least one private memory.

6. The system of claim 1, wherein said plurality of processors have different instruction set architectures.

7. The system of claim 1, further comprising a flash memory on one of said plurality of processors.

8. A method for allocating code sections to a plurality of memories, said plurality of memories including shared memories accessible by a plurality of processors and private memories on said plurality of processors, said method comprising the steps of:
receiving instructions to allocate said code sections;
allocating said code sections to said shared memories and said private memories with a linker; and
updating incomplete links corresponding to code sections not allocated.

9. The method of claim 8, further comprising the step of linking an executable program with said shared and private memories.

10. The method of claim 8, wherein said receiving step includes generating said instructions by dragging and dropping symbols within a graphical user interface.

11. The method of claim 8, further comprising the step of determining the status of said incomplete links.

12. The method of claim 11, wherein said determining step includes reporting said code sections allocated to said shared and private memories.

13. The method of claim 8, further comprising the step of relocating symbols defined by files inputted to said linker and allocated code sections.

14. The method of claim 8, further comprising the step of writing an output file for each of said plurality of processors.
